(19) United States
(12) Patent Application Publication
(10) Pub. No.: US 2018/0324472 A1
(43) Pub. Date: Nov. 8, 2018

(54) VIDEO STREAMING MANAGEMENT SYSTEM FOR ENHANCED USER ENGAGEMENT IN A SUBSCRIBED NETWORK

(71) Applicant: Sony Interactive Entertainment LLC, San Mateo, CA (US)

(72) Inventor: Richard Stern, San Mateo, CA (US)

(21) Appl. No.: 15/589,187

(22) Filed: May 8, 2017

(51) Int. Cl. H04N 21/2387; H04N 21/25; H04N 21/647; H04N 21/488; H04N 21/2668; H04N 21/222

(52) U.S. Cl. CPC H04N 21/2387; H04N 21/251; H04N 21/222; H04N 21/4884; H04N 21/2668; H04N 21/64738

(57) ABSTRACT

A video streaming management system and method are disclosed, which includes controlled display of a first visual interface that is managed by a first video service provider (VSP) of a plurality of subscribed VSPs. The video streaming management system is associated with the plurality of subscribed VSPs and a plurality of unsubscribed VSPs. An input for a first video is received via the first visual interface. The first video, based on the received input, is searched across a plurality of video services managed by the plurality of subscribed VSPs and the plurality of unsubscribed VSPs. A video service managed by a second VSP is recommended to view the first video selected from the first visual interface, based on the search. Playback of the first video is controlled from the recommended video service managed by the second video service provider.

### CROSS-REFERENCE TO RELATED APPLICATIONS/INCORPORATION BY REFERENCE

None.

### FIELD

Various embodiments of the disclosure relate to a video streaming management system. More specifically, various embodiments of the disclosure relate to a video streaming management system for enhanced display control of a visual interface for an enhanced user engagement.

### BACKGROUND

Advancements in the television and broadcasting sector have led to the development of various technologies and broadcasting platforms that are changing the way consumers' access and view media content. Video streaming services are increasingly gaining popularity among consumers, and are usually considered on-demand online entertainment source for videos, such as TV shows, movies and other streaming media. As a result of penetration and convergence of new technologies in the television, gaming, and media distribution sector, it is evident that the success of a new product or service will be dependent on the ability of the product or service provider to gain access to the content that consumers demand, and to differentiate their offering from competitors by developing technologies for enhanced consumer experience, engagement and retention. Currently, the video streaming services utilize a revenue generation model that is either per view or subscription-based. From user perspective, it is a challenging task for a user to choose one streaming services over other, due a variation in features, availability of video content, cost of services, and user interfaces of such streaming services provided by different video service providers. From a video service provider's perspective, it is not only difficult to acquire all the video content desired by various users, but also to consistently engage and retain the consumers. Thus, it may be imperative to develop effective technologies to drive consumer engagement and enhance user experience to access and view video content across various video streaming services and systems.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A video streaming management system and method for an enhanced user engagement in a subscribed network is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for a video streaming management system for enhanced user engagement, in accordance with an embodiment of the disclosure.

FIG. 2 is a block diagram that illustrates an exemplary video streaming management system for enhanced user engagement, in accordance with an embodiment of the disclosure.

FIG. 3 is a block diagram that illustrates an exemplary display device, in accordance with an embodiment of the disclosure.

FIGS. 4A and 4B are block diagrams that illustrate exemplary scenarios and visual interfaces for implementation of the disclosed video streaming management system and method for enhanced user engagement, in accordance with an embodiment of the disclosure.

FIG. 5 is a block diagram that illustrate an exemplary recommendation and playback control scenario by the exemplary video streaming management system of FIG. 2 for enhanced user engagement, in accordance with an embodiment of the disclosure.

FIGS. 6A and 6B, collectively, are a flowchart that illustrates exemplary operations for video streaming management in the video streaming management system of FIG. 2, for enhanced user engagement, in accordance with an embodiment of the disclosure.

### DETAILED DESCRIPTION

Various implementations may be found in a video streaming management system and method for enhanced user engagement in a subscribed network. Various embodiments of the disclosure provide a system and a method that simplifies video streaming management, and provides an interface to search for videos across different video service providers' platforms, notwithstanding whether a user to which the interface is provisioned is a member (for example, a subscriber) to a particular video service provider. Additionally, along with the videos, each of the video service providers that have such desired video available may also be ascertained and then presented to the user, irrespective of the user's subscription or non-subscription to the video service providers. The disclosed system proactively identifies a suitable video service provider from among different video service providers, from which a desired video may be streamed/consumed based on different criteria. The visual interface provisioned by the video streaming management system enhances consumer engagement, retention, and end user experience in order to increase consumer appeal and gain wider consumer base.

Exemplary aspects of the disclosure may comprise a video streaming management method implemented in video streaming management system. In accordance with an embodiment, the video streaming management system may be associated with a plurality of subscribed video service providers and a plurality of unsubscribed video service providers. The video streaming management system may comprise a processor that may be configured to control display of a first visual interface. The first visual interface may comprise a set of representations that corresponds to a set of videos. The first visual interface may be managed by a first video service provider of the plurality of subscribed video service providers. The processor may be configured to receive an input for a first video via the first visual interface. The processor may be further configured to search for the first video, based on the received input, across a plurality of video services managed by the plurality of subscribed video service providers and the plurality of unsubscribed video service providers. The processor may be further configured to recommend a video service managed by a second video service provider from the plurality of subscribed video service providers and the plurality of unsubscribed video service providers to view the first video selected from the first visual interface. The recommendation may be based on the search. The processor may be further configured to control playback of the first video from the recommended video service managed by the second video service provider.

In accordance with an embodiment, the processor may be further configured to determine an availability and a lowest price value of the first video from the plurality of subscribed video service providers and the plurality of unsubscribed video service providers. The video service in which the availability and the lowest price value for the first video is determined, may be selected for the recommendation. The recommended video service may be managed by one of the plurality of subscribed video service providers and the plurality of unsubscribed video service providers. In accordance with an embodiment, the processor may be further configured to segregate the received input for the first video into a significant portion and a non-significant portion for a pattern-based search for the received input via the first visual interface. At least one video may be additionally searched and recommended for view along with the first video based on the pattern-based search of the significant portion. In some embodiments, the first video service provider and the second video service provider may be same. In some embodiments, the first video service provider and the second video service provider may be different.

In accordance with an embodiment, the processor may be further configured to determine a server load for each of a set of video servers managed by the plurality of subscribed video service providers and the plurality of unsubscribed video service providers. The server load may be determined at a time instant associated with the search of the first video for the set of video servers in which the availability of the first video may be determined. A video stream of the first video may be received from a video server in which the determined server load may be lowest from the set of video servers. The video server in which the determined server load may be lowest from the set of video servers may correspond to the recommended video service managed by the second video service provider to view the first video.

In accordance with an embodiment, the processor may be further configured to provide a direct navigation to the first video for the playback of the first video from the recommended video service managed by the second video service provider. The playback of the first video may be controlled independent of a requirement to re-search the received input from a second visual interface (for example, a home page) managed by the second video service provider.

In accordance with an embodiment, the processor may be further configured to search for a first scene within the first video based on closed captioning information or sub-titles of the first video to start the playback of the first video from the first scene. In some embodiments, the processor may be further configured to search a first scene, based on the received input, across a plurality of videos managed by the plurality of subscribed video service providers and the plurality of unsubscribed video service providers. The search for the first scene may be executed based on closed captioning information or sub-titles of the plurality of videos to start playback of a portion of a second video that corresponds to the first scene.

In accordance with an embodiment, the processor may be further configured to receive user-information for a plurality of users associated with a plurality of display devices communicatively coupled to the video streaming management system. The processor may be configured to classify the plurality of users associated with the plurality of display devices based on a plurality of user segmentation parameters. In some embodiments, the set of representations that correspond to the set of videos may be selected for placement on the first visual interface rendered on a display device, based on a plurality of defined criterions. The plurality of defined criterions may include a video viewing habit of a user associated with the display device, a plurality of user segmentation parameters, a list of current trending videos in a social network, a plurality of specified parameters in a user profile of the user of the display device, and a local weather condition of a geographical area in which the display device may be located. The processor may be further configured to determine a placement of different video categories on the first visual interface using a layout that may be selected based on the plurality of defined criterions. The set of representations may be segregated into the different video categories in the layout.

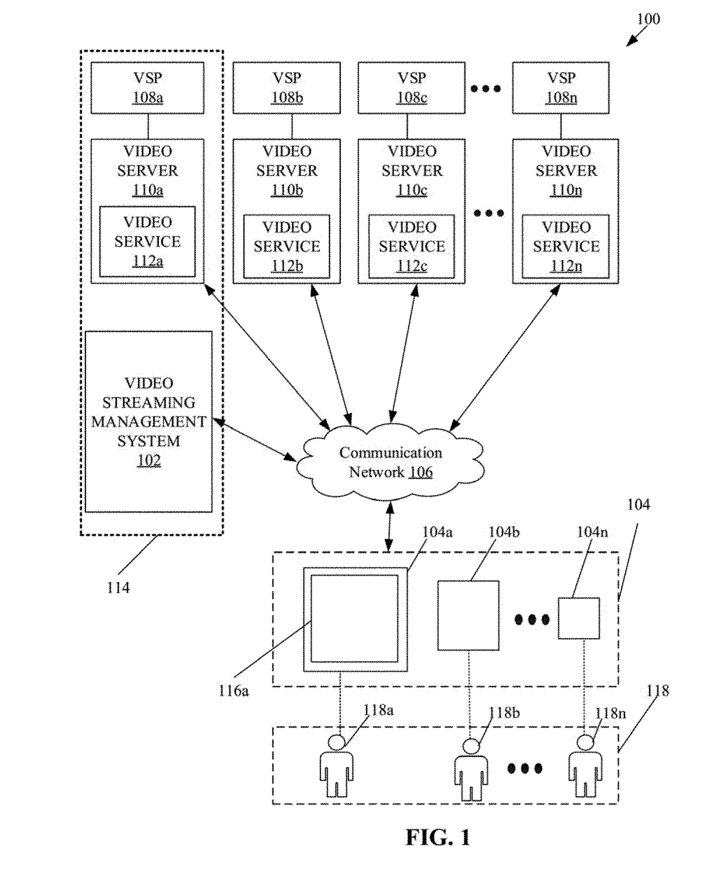

FIG. 1 is a block diagram that illustrates an exemplary network environment for a video streaming management system for enhanced user engagement, in accordance with an embodiment of the disclosure. With reference to FIG. 1, there is shown an exemplary network environment 100. The exemplary network environment 100 may include a video streaming management system 102, a plurality of display devices 104 (such as display devices 104a, 104b, . . . , 104n), and a communication network 106. A plurality of video service providers (VSPs) 108a, 108b, 108c, . . . , 108n, a plurality of video servers 110a, 110b, 110c, . . . , 110n, and a plurality of video services 112a, 112b, 112c, . . . , 112n are also shown in the exemplary network environment 100. A plurality of users 118 (such as the users 118a, 118b, . . . , 118n) may be associated with the plurality of display devices 104 respectively, as shown. There is also shown a first visual interface 116a rendered on the display device 104a. The plurality of display devices 104 may be communicatively coupled to the video streaming management system 102, via the communication network 106.

The video streaming management system 102 may comprise suitable logic, circuitry, interfaces, and/or code that may be configured to communicate with the plurality of display devices 104, via the communication network 106. The video streaming management system 102 may be configured to display the first visual interface 116a on a display device, such as the display device 104a. The user 118a may provide an input, such as a video title to search for a desired video via the first visual interface 116a. The video streaming management system 102 may be configured to search, based on the received input, across different VSPs 108a, 108b, 108c, . . . , 108n. An example of the video streaming management system 102 may be a video streaming management server operated by a first VSP (such as the VSP 108a) of the different VSPs 108a, 108b, 108c, . . . , 108n.

Each of the plurality of display devices 104a, 104b, . . . , 104n may comprise suitable logic, circuitry, interfaces, and/or code that may be configured to communicate with the video streaming management system 102, via the communication network 106. Each of the plurality of display devices 104a, 104b, . . . , 104n may communicate one or more requests to subscribe for a video service to respective VSPs 108a, 108b, 108c, . . . , 108n. Examples of the plurality of display devices 104 may include, but are not limited to, a video game console, a mobile device, such as a smart phone, a tablet computer, a web-enabled device, a laptop, a wearable electronic device, Internet Protocol television (IPTV), and/or other computing or display devices.

The communication network 106 may include a communication medium through which the video streaming management system 102 may communicate with the plurality of display devices 104. The communication network 106 may be a wired or wireless communication network. Examples of the communication network 106 may include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet. Various devices in the exemplary network environment 100 may be configured to connect to the communication network 106, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), IEEE 802.11, 802.16, Long Term Evolution (LTE), Light Fidelity (Li-Fi), and/or other cellular communication protocols including variants thereof.

Each of the plurality of VSPs 108a, 108b, 108c, . . . , 108n refer to an entity or an operator that provides an end-user, such as the plurality of users 118, with on-demand or live media items, such as movies, TV shows, videos related to upcoming events, or other video programming. Each of the plurality of video servers 110a, 110b, 110c, . . . , 110n may refer to a media content server, a cloud server, or a media streaming or distribution system, independently managed by one VSP, as shown. Each of the plurality of video servers 110a, 110b, 110c, . . . , 110n may store its own video content managed by corresponding VSPs. For example, the video server 110a may be used by the VSP 108a to provide a video streaming service, such as the video service 112a. Similarly, the video server 110b may be used and operated by a different entity, such as the VSP 108a, to provide another video streaming service, such as the video service 112b. Each of the plurality of video services 112a, 112b, 112c, . . . , 112n may refer to an on-demand online video entertainment source for TV shows, movies and other streaming media. Such video services usually require certain fee, such as either pay per video view or a periodic subscription to access the video service. Such video services may provide an alternative to cable and satellite on demand service.

In operation, the user 118a may power “ON” the display device 104a. The user 118a may desire to view a video (for example, a video on-demand (VOD) content) on the display device 104a. Based on a request received from the display device 104a, the video streaming management system 102 may be configured to control display of the first visual interface 116a. The first visual interface 116a may comprise at least a set of representations that corresponds to a set of videos. The video streaming management system 102 may be configured to control display of the first visual interface 116a on the display device 104a. The plurality of users 118 associated with the plurality of display devices 104 may or may not be members (registered subscribers) of the video services 112a, 112b, 112c, . . . , 112n managed by the plurality of VSPs 108a, 108b, 108c, . . . , 108n. For example, the user 118a associated with the display device 104a may be a member (such as a registered subscriber) of certain video services (for example, video services 112a and 112b that provides, VOD content, such as TV shows, movies and other media streaming services), managed by the VSPs 108a and 108b. The user 118a may not be a member of other video services (for example, video services 112c, . . . , 112b) managed by the VSPs 108c, . . . , 108n. The displayed first visual interface 116a may be managed by a first VSP (such as the VSP 108a) of the plurality of subscribed VSPs. Thus, the video streaming management system 102 may be associated with a plurality of subscribed VSPs (such as the VSPs 108a and 108b) and a plurality of unsubscribed VSPs (such as the VSPs 108c, . . . , 108n) for a user account (such as the user account of the user 118a).

In some embodiments, the plurality of users 118 associated with the plurality of display devices 104 may be members of the subscribed network 114. The subscribed network 114 may also be referred to as a home network (for example, a PlayStation network (PSN)). In such embodiments, the video streaming management system 102, the first VSP (such as the VSP 108a), and the video server 110a, may also be part of the home network (i.e. the subscribed network 114). The subscribed network 114 may refer to a dedicated digital media entertainment service network offering a bouquet of basic and premium services based on a subscription level of the user account. For example, certain online or offline gaming services may be provided at a basic subscription level. Further, certain other services, such as the video service 112a, may be subscribed by a user (such as the user 118a) in a premium subscription level. The video streaming management system 102 and at least one video server, such as the video server 110a, of the plurality of video servers 110a, 110b, 110c, . . . 110n, may be managed by the VSP 108a (for example, a same service provider that offers the subscribed network 114 or a service provider who may be a part of the home network). Other video servers, such as the video servers 110b, 110c, . . . , 110n, may not be managed by the VSP 108a.

In accordance with an embodiment, the video streaming management system 102 may be configured to receive user-information for the plurality of users 118 associated with the plurality of display devices 104 communicatively coupled to the video streaming management system 102. The user-information may correspond to at least one of a user profile (created at the time of creation of a user account in the subscribed network 114) or tracked user activity of the plurality of users 118. Based on the received user-information for the plurality of users 118 associated with a plurality of user accounts, the video streaming management system 102 may be configured to check whether each of the plurality of users 118 associated with the plurality of user accounts are new consumers or existing consumers. Thus, a variety of data, such as, but not limited to, user-interests, likes, dislikes, version of current products or devices owned, may be available for consumers, such as the user 118a, which may be utilized to generate insights. The video streaming management system 102 may be configured to classify the plurality of users 118 associated with the plurality of display devices 104 based on a plurality of user segmentation parameters. The plurality of user segmentation parameters for the plurality of users 118 may include a geographical location, an age group, a language preference, a gender, and specified user-interests of each of the plurality of users 118. The plurality of user segmentation parameters for the plurality of users 118 may further include a subscription level of the user account, a device-type of the plurality of display devices 104a, 104b, . . . , 104n owned by the plurality of users 118.

In accordance with an embodiment, the video streaming management system 102 may be configured to control display of the set of representations that correspond to the set of videos based on a video viewing habit of a user (such as the user 118a) associated with a display device (such as the display device 104a). The video streaming management system 102 may be configured to detect a change in a trend in viewing habits of the user 118a. Thereafter, based on the detected change in the trend in viewing habits of the user 118a, the video streaming management system 102 may be configured to update the set of representations for the user 118a in real time or near-real time based on the detected change. The display of the set of representations may also be controlled based on the plurality of user segmentation parameters. For example, a different set of representations may be displayed for different users located at different geographical location or different age-group.

The video streaming management system 102 may be configured to dynamically select a placement of the set of representations on the first visual interface 116a based on a plurality of defined criterions. The plurality of defined criterions may include a video viewing habit of the user 118a associated with the display device 104a, the plurality of user segmentation parameters, a list of current trending videos in a social network, or a plurality of specified parameters in the user profile of the user 118a of the display device 104a. In some embodiments, the placement of the set of representations on the first visual interface 116a may be based on a local weather condition of a geographical area in which the display device 104a may be located. For example, the video streaming management system 102 may detect that the local weather condition for the geographical area, in which the display device 104a is located, indicate a snowfall. The video streaming management system 102 may then retrieve representations of certain TV shows or movies suited for the detected local weather condition, and render on the first visual interface 116a specifically for the user 118a.

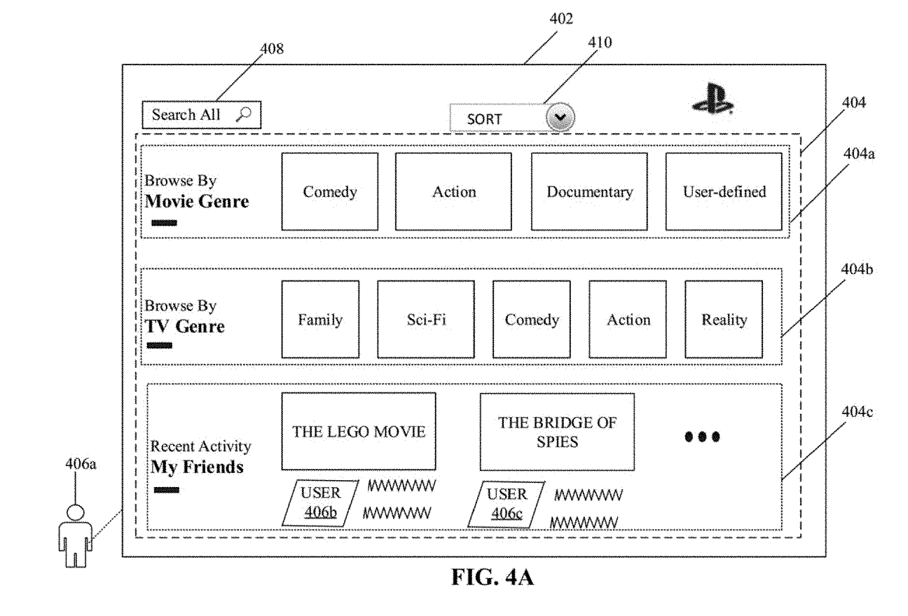

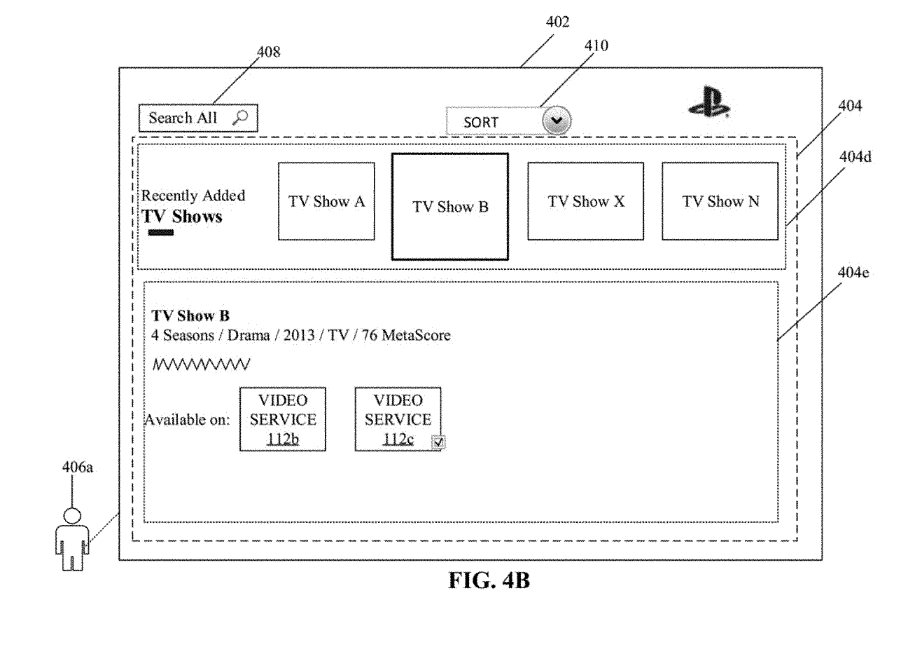

In accordance with an embodiment, the video streaming management system 102 may be further configured to automatically categorize a plurality of videos available across the plurality of video services 112a, 112b, 112c, . . . , 112n, in different genre, for example, action, comedy, documentary, family, adult, kids-friendly, and the like. The categorization may be done using closed captioning of plurality of videos, specified ratings, or analysis of one or more video segments of each video of the plurality of videos. The video streaming management system 102 may be further configured to determine a placement of different video categories on the first visual interface 116a using a layout. The layout may be selected based on the plurality of defined criterions or user-preferences. The set of representations may be segregated into the different video categories in the layout. An exemplary visual interface with a layout that includes different video categories is shown, for example, in FIG. 4A.

In accordance with an embodiment, the video streaming management system 102 may be configured to receive an input for a first video via the first visual interface 116a. The user 118a may provide an input, for example, a video title for the first video, via the first visual interface 116a. The video streaming management system 102 may be further configured to search for the first video, based on the received input, across the plurality of video services 112a, 112b, 112c, . . . , 112n. The first visual interface 116a allows searching for the first video across the plurality of video services 112a, 112b, 112c, . . . , 112n managed by the plurality of subscribed VSPs and the plurality of unsubscribed VSPs. The video streaming management system 102 may be configured to recommend a video service (such as the video service 112c) managed by a second VSP (such as the VSP 108c) from the plurality of subscribed VSPs and the plurality of unsubscribed VSPs to view the first video selected from the first visual interface 116a. The recommendation may be based on the search.

In some embodiments, the video streaming management system 102 may be further configured to determine an availability and a lowest price value of the first video from the plurality of subscribed VSPs (such as the VSP 108a and 108b) and the plurality of unsubscribed VSPs (such as the VSP 108c, . . . , 108n). The video service (such as the video service 112c) in which the availability and the lowest price value for the first video is determined, may be selected for the recommendation. In some embodiments, the recommendation may be based on, for example, server load or a speed of server response. The video streaming management system 102 may be configured to determine a server load for each of a set of video servers (such as the video servers 110a, 110b, and 110c). The server load may be determined for the set of video servers in which the availability of the first video is determined. The server load may be determined at a time instant associated with the search of the first video. The video server (such as the video server 110c) in which the determined server load may be lowest from the set of video servers may be recommended to view the first video. A video stream of the first video may be received from the video server in which the determined server load may be lowest from the set of video servers.

In accordance with an embodiment, the video streaming management system 102 may be configured to control playback of the first video from the recommended video service (such as the video service 112c) managed by the second VSP (such as the VSP 108c). The video streaming management system 102 may be further configured to provide a direct navigation to the first video for the playback of the first video from the recommended video service (such as the video service 112c) managed by the second VSP. The playback of the first video may be controlled independent of a requirement to re-search the received input, for example, the video title for the first video searched in the first visual interface 116a, from a second visual interface (for example, a home page of the video service 112c) managed by the second VSP.

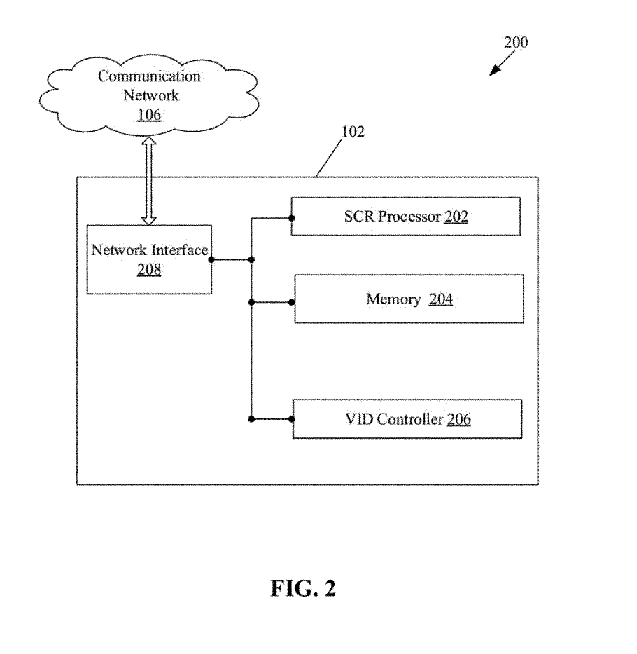

FIG. 2 is a block diagram that illustrates an exemplary video streaming management system for enhanced user engagement, in accordance with an embodiment of the disclosure. FIG. 2 is described in conjunction with elements from FIG. 1. With reference to FIG. 2, there is shown a block diagram 200 of an exemplary video streaming management, such as the video streaming management system 102. The video streaming management system 102 may include one or more processors or circuits, such as a search, cataloging, and recommendation (SCR) processor 202, a memory 204, a visual interface display (VID) controller 206, and a network interface 208. There is also shown the communication network 106 (of FIG. 1).

In accordance with an embodiment, the SCR processor 202 may be communicatively coupled to the memory 204, the VID controller 206, and the network interface 208. The network interface 208 may be configured to communicate with the plurality of display devices 104a, 104b, . . . , 104n, via the communication network 106, under the control of the VID controller 206.

The SCR processor 202 may be a special-purpose hardware processor that may comprise suitable logic, circuitry, interfaces, and/or code that may be configured to search for videos across different VSPs' platforms (for example, the video services 112a, 112b, 112c, . . . , 112n), notwithstanding whether a user to which the visual interface (such as the first visual interface 116a) is provisioned is a member (or subscriber) to a particular VSP. In some embodiments, the SCR processor 202 may be configured to execute a set of instructions stored in the memory 204. Examples of the SCR processor 202 may be an Application-Specific Integrated Circuit (ASIC) processor, a Complex Instruction Set Computing (CISC) processor, and/or other processors or control circuits.

The memory 204 may comprise suitable logic, circuitry, interfaces, and/or code that may be configured to store a set of instructions executable by the SCR processor 202 or the VID controller 206. The memory 204 may be configured to store one or more algorithms that are executed by the SCR processor 202 to extract user-information of the plurality of users 118 associated with the plurality of display devices 104a, 104b, . . . , 104n. The memory 204 may be further configured to store operating systems and associated applications of the video streaming management system 102. The memory 204 may be further configured to store catalogs of a plurality of videos that are available for viewing by an end-user. The SCR processor 202 may be configured to periodically update the catalogs of videos of each of the plurality of VSPs 108a, 108b, 108c, . . . , 108n. Examples of implementation of the memory 204 may include, but are not limited to, Read Only Memory (ROM), Random Access Memory (RAM), Dynamic Random Access Memory (DRAM), Static Random Access Memory (SRAM), Thyristor Random Access Memory (T-RAM), Zero-Capacitor Random Access Memory (Z-RAM), cache memory, volatile memory, a flash memory, Hard Disk Drive (HDD), a Solid-State Drive (SSD), and/or a removable media drive.

The VID controller 206 may be a special-purpose hardware processor that may comprise suitable logic, circuitry, interfaces, and/or code that may be configured render one or more visual interfaces to allow viewing of a plurality of videos on the plurality of display devices 104. In some embodiments, the VID controller 206 may be implemented as a separate processor or special-purpose circuitry in the video streaming management system 102. In some embodiments, the VID controller 206 and the SCR processor 202 may be implemented as an integrated processor or a cluster of processors that perform the operations of the VID controller 206 and the SCR processor 202.

The network interface 208 may comprise suitable logic, circuitry, interfaces, and/or code that may be configured to communicate with the video streaming management system 102, via the communication network 106 (FIG. 1). The network interface 208 may be implemented by use of known technologies to support wired or wireless communication of the video streaming management system 102 with the communication network 106. Components of the network interface 208 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the SCR processor 202 may be configured to receive user-information for the plurality of users 118 from the display devices 104. The user-information may include a user account identifier (ID), a type of subscription account (such as basic, premium, or elite), one or more video services currently subscribed, and a product code and version for various display devices (e.g. a gaming console, a smart TV, or other display device) owned by each user. The user-information may also include a lifetime value associated with each user account. The lifetime value may refer to a total monetary value that is spent by a user associated with a user account ID. The lifetime value includes not only the monetary value spent on the service associated with the particular subscriber account but also the monetary value spent on other products and services previously owned by the user. The user-information may also include device IDs of each of the plurality of display devices 104, a device-type, a device version, a user ID of a user associated with each display device, a geographical location ID, an age group, and a gender of the user associated with each display device. In some embodiments, the user-information may also include a user name of each of the plurality of users 118, a timestamp of input received via visual interfaces (such as the first visual interface 116a) from the plurality of display devices 104, a language preference, likes, dislikes, specified user-interests, version of the applications installed in each of the plurality of display devices 104, and user-specified settings of each user related to a user account.

The SCR processor 202 may be further configured to monitor and track a last change in video viewing habits for each user of the plurality of users 118, a current social media trend for different geographical locations and users, an average time spent by each user to view a video service in a session, and a relationship between different users of the plurality of users 118. For example, the user 118a and the user 118b may be either close friends, acquaintance, or unknown to each other. It is to be understood that there may be other user-information, without limiting the scope of the disclosure, that may be stored and continuously updated in the database provided in the memory 204.

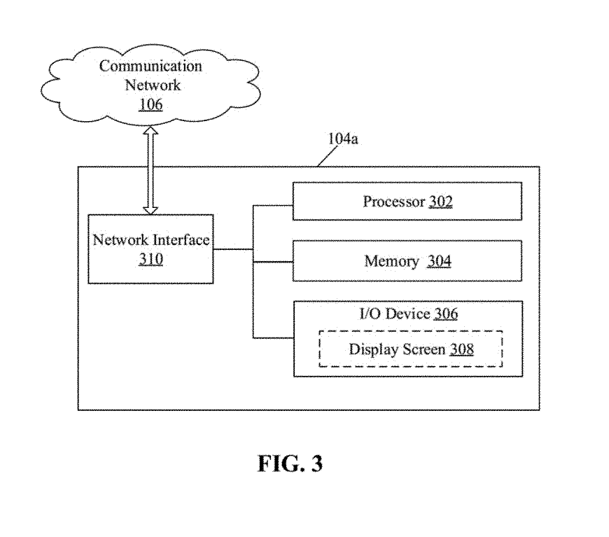

The SCR processor 202 may be further configured to generate a plurality of catalogs of videos offered by each of the plurality of VSPs 108a, 108b, 108c, . . . , 108n. In some embodiments, a catalog of videos may be provided by each of the plurality of VSPs 108a, 108b, 108c, . . . , 108n, which may then be processed to generate a common cataloging structure for the videos managed by the plurality of VSPs 108a, 108b, 108c, . . . , 108n. The functions and/or operations performed by the video streaming management system 102, as described in FIG. 1, may be performed by the SCR processor 202 and the VID controller 206 in association with the memory 204. Other operations by the SCR processor 202 and the VID controller 206, are further described, for example, in FIGS. 3, 4A, 4B, 5, 6A, and 6B.

FIG. 3 is a block diagram that illustrates an exemplary display device, in accordance with an embodiment of the disclosure. FIG. 3 is described in conjunction with elements from, for example, FIG. 1 and FIG. 2. With reference to FIG. 3, there is shown a block diagram of an exemplary display device, such as the display device 104a. The display device 104a may include one or more processors or circuits, such as a processor 302, a memory 304, an input/output (I/O) device 306, a display screen 308, and a network interface 310. The I/O device 306 may include the display screen 308.

In accordance with an embodiment, the processor 302 may be communicatively coupled to the memory 304, the I/O device 306, the display screen 308, and the network interface 310. The network interface 310 may be configured to facilitate communication between the video streaming management system 102 and the plurality of video servers 110a, 110b, 110c, . . . , 110n, via the communication network 106.

The processor 302 may comprise suitable logic, circuitry, interfaces, and/or code that may be configured to execute a set of instructions stored in the memory 304. The processor 302 may be further configured to display one or more visual interfaces (such as the first visual interface 116a) received by the network interface 310.

The memory 304 may comprise suitable logic, circuitry, and/or interfaces that may be configured to store a set of instructions executable by the processor 302. The memory 304 may be configured to store a plurality of view applications to access a video service, such as an internet-based video streaming service or a gaming service, associated with a user account. The memory 304 may be further configured to store operating systems and associated applications of the display device 104a. Examples of implementation of the memory 304 may include, but are not limited to, Random Access Memory (RAM), Read Only Memory (ROM), Solid-state Drive (SSD), Hard Disk Drive (HDD), and/or a Flash memory.

The I/O device 306 may comprise suitable logic, circuitry, interfaces, and/or code that may be configured to receive an input from and provide an output to the user 118a associated with the display device 104a. Examples of the input devices may include, but are not limited to, a camcorder, a touch screen, a joystick, a keyboard, a microphone, a motion sensor, a light sensor, and/or a docking station. Examples of the output devices may include, but are not limited to, the display screen 308, a projector screen, and/or a speaker.

The network interface 310 may comprise suitable logic, circuitry, interfaces, and/or code that may be configured to communicate with the video streaming management system 102, via the communication network 106 (FIG. 1). The network interface 310 may be implemented by use of known technologies to support wired or wireless communication of the display device 104a with the communication network 106. The network interface 310 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, a user, such as the user 118a, may utilize the I/O device 306, to provide an input to communicate one or more requests to view a video, to the video streaming management system 102. The network interface 310 may be configured to receive the first visual interface 116a from the video streaming management system 102. The user 118a associated with the display device 104a may be a subscriber of certain video services (for example, video services 112a and 112b), managed by the VSPs 108a and 108b. The user 118a may not be a member of other video services (for example, video services 112c, . . . , 112b) managed by the VSPs 108c, . . . , 108n. The displayed first visual interface 116a may be managed by a first VSP (such as the VSP 108a) of the plurality of subscribed VSPs. The user 118a may desire to view a first video, for example, a movie on the display device 104a. The user 118a may provide an input, for example, a video title to search for the first video, across the plurality of video services 112a, 112b, 112c, . . . , 112n managed by the plurality of subscribed VSPs and the plurality of unsubscribed VSPs. The user 406a may select the first video that is to be consumed and a video service (or a VSP) from which the video is to be obtained. In cases where the user 406a is pre-subscribed to a video service (or VSP), the user 406a may obtain and consume such content from that particular video service or the VSP. In cases, where a particular video is available from a video service (or VSP) for which the user 406a is not a member or subscriber, the user 406a, may then be able to become a subscriber of such provider in order to obtain the desired video. The displayed first visual interface 116a may be content driven which allows the user 406a to first confirm an availability of a desired video based on the search across the plurality of video services 112a, 112b, 112c, . . . , 112n, and then select a suitable video service (or VSP) to view such desired video.

FIGS. 4A and 4B are block diagrams that illustrate exemplary scenarios and visual interfaces for implementation of the disclosed video streaming management system and method for enhanced user engagement, in accordance with an embodiment of the disclosure. FIGS. 4A and 4B are described in conjunction with elements from the FIGS. 1, 2, and 3. With reference to FIG. 4A, there is shown a visual interface 402. The visual interface 402 may refer to a graphical user interface (GUI) that may include one or more UI elements, such as the UI elements 408 and 410. There is also shown a plurality of different sections 404a, 404b, and 404c in a layout 404 of the visual interface 402.

In accordance with the exemplary scenario, the visual interface 402 may correspond to the first visual interface 116a. The user 406a associated with the visual interface 402 may correspond to the user 118a associated with the display device 104a (FIG. 1). The VID controller 206 may be configured to control display of the visual interface 402 on the display device 104a. The SCR processor 202 may read and process the catalogs of a plurality of videos that belong to the plurality of video services 112a, 112b, 112c, . . . , 112n. The SCR processor 202 may be configured to categorize the plurality of videos available across the plurality of video services 112a, 112b, 112c, . . . , 112n, in different genre, for example, comedy action, documentary, a user-defined genre, family, science fiction (Sci-fi), reality, adult, kids-friendly, and the like. The categorization may be done based on the metadata of each of the plurality of videos and the catalog. The SCR processor 202 may be configured to arrange the categorized genres in a common group in accordance to a common video-type of the plurality of videos. For example, if the video-type is tagged as “movie”, different genre of movies may be grouped. Similarly, if the video-type is tagged as “TV shows”, “upcoming events”, “< user-specific> watch list”, the SCR processor 202 may be configured to automatically group representation of different videos or genre of different videos according to the video-type.

The SCR processor 202 may be configured to determine a placement of different video categories and video-types on the first visual interface 116a using a layout, such as the layout 404. The layout 404 may be dynamically selected and then periodically updated based on the plurality of defined criterions or user-preferences. For example, the section 404a and the section 404b of the layout 404 includes a group of different genres for movies and TV shows, respectively, as shown. The SCR processor 202 may be configured to determine and control display of recent activities of friends (such as the users 406b and 406c) of the user 406a, on the visual interface 402. The recent activities may correspond to viewing of certain videos of the plurality of videos from the plurality of video services 112a, 112b, 112c, . . . , 112n. For example, “Richard” (username of the user 406b) watched “The Lego Movie” from the video service 112b (for example, Netflix) about <“6”> hrs ago, may be displayed on the visual interface 402 at section 404c. In another example, “Bikash” (username of the user 406c) is currently watching “The Bridge of Spies” movie from the video service 112a (for example, PlayStation Video) and is <30 min> into the movie, may be displayed on the visual interface 402 at section 404c. Thus, the SCR processor 202 may be configured to determine and control display of a username of a friend (such as the user 406b or 406c, the video title that is/was viewed, a video service from which the video is/was viewed by a user, a current time into the video (if it is an ongoing activity), a video-type (such as a movie, a TV show, or an upcoming event), or a time elapsed after watching the video.

The visual interface 402 allows the user 406a to sort the plurality of videos by the UI element 410, based on various parameters, such as a current trend of a video in a social network, popularity, latest video releases, latest video additions to a particular video service across the plurality of video services 112a, 112b, 112c, . . . , 112n, a user-defined parameter, and the like. The visual interface 402 further allows the user 406a to search, by the UI element 408, for videos across different VSPs platforms (such as the plurality of video services 112a, 112b, 112c, . . . , 112n), irrespective of a condition that the user 406a to which the visual interface 402 is provisioned, is a member or not to the plurality of video services 112a, 112b, 112c, . . . , 112n.

With reference to FIG. 4B, there is shown the visual interface 402 with sections 404d and 404e in the layout 404 to depict an availability of a particular video on different video services. FIG. 4B is described in conjunction with elements from the FIG. 4A. The SCR processor 202 may be configured to receive an input, via the visual interface 402, for selection of a video, such as the “TV show B”. The user 406a may select the video from a section 404d of the visual interface 402. The section 404d of the visual interface 402 may include representations (for example, representative images) that correspond to the recently added TV shows. The SCR processor 202 may be configured to determine an availability of the video (such as the “TV show B”) from the plurality of subscribed VSPs (such as the VSPs 108a and 108b) and the plurality of unsubscribed VSPs (such as the VSPs 108c, . . . , 108n). For example, the SCR processor 202 may determine that the video (such as the “TV show B”) is available on the video service 112b and the video service 112c managed by different VSPs 108b and 108c respectively. The VID controller 206 may be configured to control the display of the video service 112b and 112c on the visual interface 402 such that the user 406a may select both the video that is to be consumed and the video service (or the VSP) from which the video is to be obtained. In cases where the user 406a is a member or subscriber to a video service (or VSP), the user 406a may obtain and consume such content from that particular video service or the VSP. In cases where a particular video is available from a video service (or VSP) that the user 406a is not a member or subscriber, the user 406a, may then be able to become a subscriber of such provider in order to obtain the video of choice. Thus, the displayed visual interface 402 is content driven which allows the user 406a to first find availability and select an arbitrary video of choice and then make a decision to select a suitable video service (or VSP) to consume such arbitrary video of choice. In some embodiments, the VID controller 206 may be configured to display a recommendation for a video service from the plurality of subscribed VSPs (such as the VSPs 108a and 108b) and the plurality of unsubscribed VSPs (such as the VSPs 108c, . . . , 108n) to view the selected video based on defined criterions.

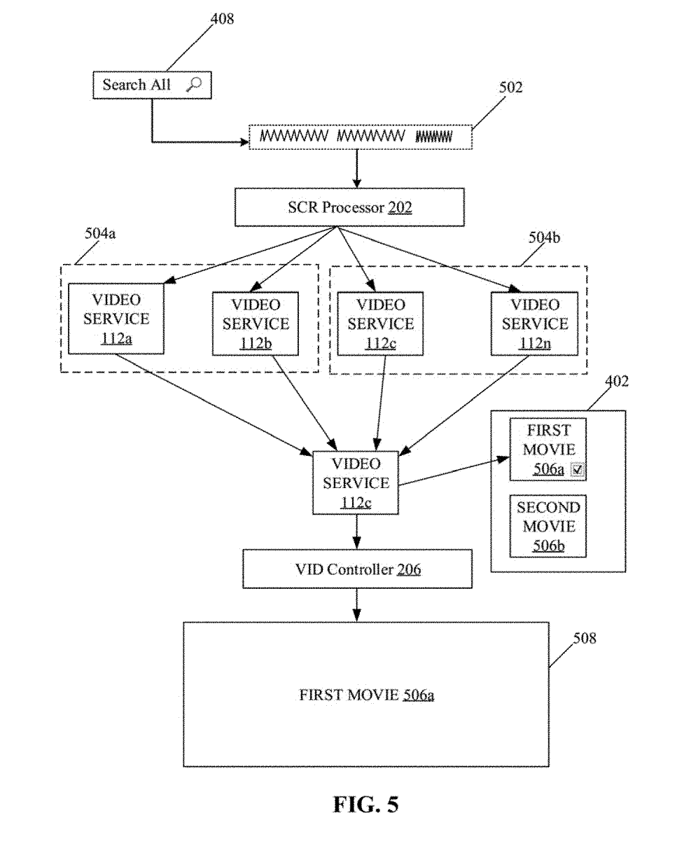

FIG. 5 is a block diagram that illustrate exemplary recommendation and playback control scenario by the exemplary video streaming management system of FIG. 2 for enhanced user engagement, in accordance with an embodiment of the disclosure. FIG. 5 is described in conjunction with elements from the FIGS. 1, 2, 3, 4A, and 4B. With reference to FIG. 5, there is shown a video title 502 (for example, “Ghostbusters 1”) provided by the user 406a (FIG. 4A) as input in the UI element 408 to search for a first video (such as the first movie 506a). The SCR processor 202 may be configured to receive the input (i.e. the video title 502) for the first video via the visual interface 402 (FIG. 4A). The SCR processor 202 may be further configured to search for the first video, based on the received input, across the plurality of video services 112a, 112b, 112c, . . . , 112n. The UI element 408 of the visual interface 402 allows the user 406a to search for the first video (such as the first movie 506a) across the plurality of video services 112a, 112b, 112c, . . . , 112n managed by the plurality of subscribed VSPs (indicated by a first grouping 504a) and the plurality of unsubscribed VSPs (indicated by a second grouping 504b), although each of the plurality of subscribed VSPs and the plurality of unsubscribed VSPs are third parties to each other. The SCR processor 202 may be configured to recommend one of the plurality of video services 112a, 112b, 112c, . . . , 112n. For example, the SCR processor 202 determines that the first video is available from the video service 112c at the lowest price value. The SCR processor 202 may determine that a speed of server response from the video server 110c that provisions the video service 112c, may be highest from the plurality of video servers 110a, 110b, 110c, . . . 110n. Thus, the SCR processor 202 may be configured to recommend the video service 112c managed by a second VSP (such as the VSP 108c) to view the first video (such as the first movie 506a) selected from the visual interface 402. In some embodiments, the recommendation may be based on server load. A video stream of the first video may be received from the video server (for example, the video server 110c) in which the determined server load may be lowest from the set of video servers 110a, 110b and 110c, in which the first video is determined as available.

In accordance with an embodiment, the VID controller 206 may be configured to control playback of the first video (such as the first movie 506a) from the recommended video service (such as the video service 112c) managed by the second VSP (such as the VSP 108c). The user 406a may need not to visit the home page of the visual interface 508 managed by the second VSP (such as the VSP 108c) to repeat the search for the video title 502 on the visual interface 508 managed by the second VSP. The VID controller 206 may be configured to provide a direct navigation (or a deep linking) to the first video for the playback of the first video from the recommended video service (such as the video service 112c) managed by the second VSP (such as the VSP 108c).

In some embodiments, the SCR processor 202 may be configured to segregate the received input, such as the video title 502, for the first video into a significant portion (for example, identified significant words or letters, such as “ghostbuster” of the video title 502) and a non-significant portion (for example, identified non-significant words or letters, such as “1”). The significant portion may then be utilized for a pattern-based search across the plurality of video services 112a, 112b, 112c, . . . , 112n managed by the plurality of subscribed VSPs and the plurality of unsubscribed VSPs. Based on the pattern-based search of the significant portion, at least one video, such as the second movie 506b (e.g. “Ghostbusters 2”), may be additionally searched and recommended for view along with the first video on the visual interface 402 managed by a first VSP (such as the VSP 108a) of the plurality of subscribed VSPs. In cases, where the second movie 506b is available on the home network, the video service 112a associated with the VSP 108a, may additionally be recommended to view the second movie 506b.

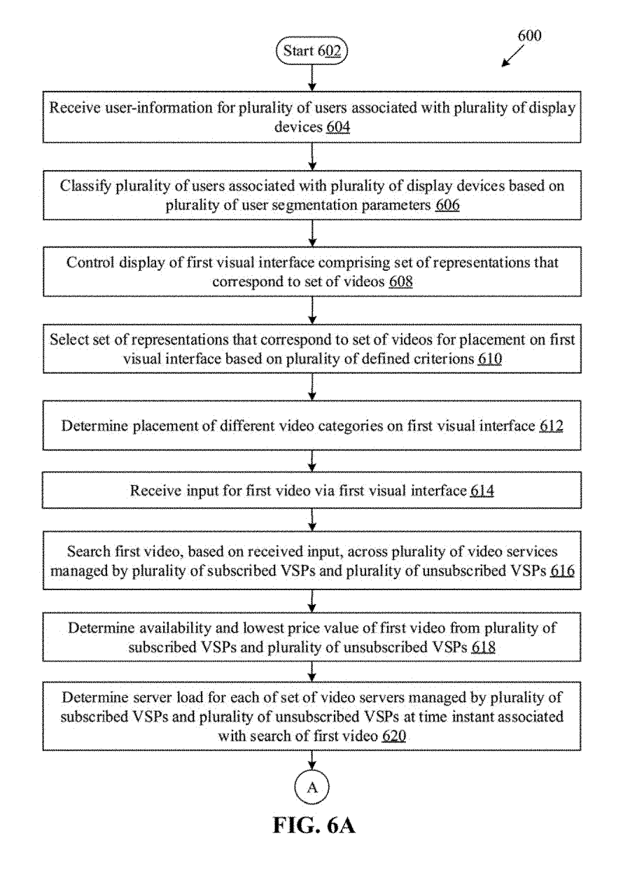

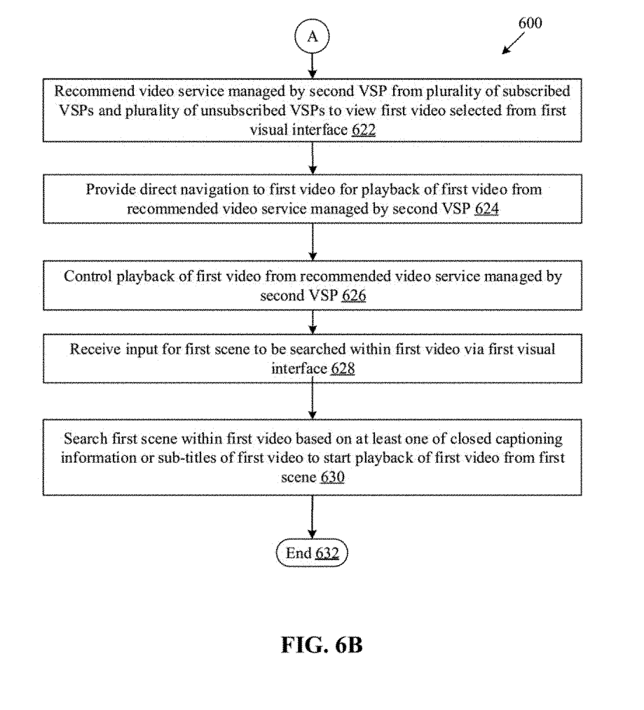

FIGS. 6A and 6B, collectively, are a flowchart that illustrates exemplary operations for video streaming management in the video streaming management system of FIG. 2, for enhanced user engagement, in accordance with an embodiment of the disclosure. With reference to FIGS. 6A and 6B, there is shown a flow chart 600. The flow chart 600 is described in conjunction with FIGS. 1, 2, 3, 4A, 4B, and 5. The method starts at 602 and proceeds to 604.

At 604, user-information for the plurality of users 118 associated with the plurality of display devices 104 may be received. The plurality of display devices 104 may be communicatively coupled to the video streaming management system 102. The SCR processor 202 may be configured to receive the user-information for the plurality of users 118, via the network interface 208. The received user-information are described in details, for example, in FIG. 2.

At 606, the plurality of users 118 associated with the plurality of display devices 104 may be classified based on a plurality of user segmentation parameters. The SCR processor 202 may be configured to classify the plurality of users 118 associated with the plurality of display devices 104 based on the plurality of user segmentation parameters. The plurality of user segmentation parameters for the plurality of users 118 may include a geographical location, an age group, a language preference, a gender, and specified user-interests of each of the plurality of users 118. The different user segmentation parameters are described in details, for example, in FIG. 1.

At 608, display of a first visual interface (such as the first visual interface 116a (FIG. 1) or the visual interface 402 (FIGS. 4A, 4B, and 5)), may be controlled. The first visual interface may comprise a set of representations that corresponds to a set of videos. The first visual interface may be managed by a first VSP (such as the VSP 108a of the subscribed network 114) of the plurality of subscribed VSPs (such as the VSP 108a and 108b). The VID controller 206 may be configured to control display of the first visual interface. An example of the display control of the visual interface 402 is shown and described in FIGS. 4A and 4B.

At 610, the set of representations that correspond to the set of videos may be selected for placement on the first visual interface rendered on a display device (such as the display device 104a). The selection may be done by the SCR processor 202 based on a plurality of defined criterions that includes a video viewing habit of the user 118a associated with the display device 104a, the plurality of user segmentation parameters, a list of current trending videos in a social network, a plurality of specified parameters in a user profile of the user 118a of the display device 104a, and a local weather condition of a geographical area in which the display device 104a is located.

At 612, a placement of different video categories on the first visual interface may be determined. The placement of different video categories may be determined using a layout that is selected based on the plurality of defined criterions. The set of representations may be segregated into the different video categories in the layout (such as the layout 404). An example is shown and described in FIGS. 4A and 4B.

At 614, an input for a first video may be received via the first visual interface. For example, the user 118a may provide an input, for example, a video title for the first video, via the first visual interface 116a. The SCR processor 202 may receive the input for the first video, via the network interface 208. An example of the received input is shown and described in FIGS. 4A and 5.

At 616, the first video, based on said received input, may be searched across the plurality of video services 112a, 112b, 112c, . . . , 112n managed by the plurality of subscribed VSPs and the plurality of unsubscribed VSPs. The SCR processor 202 may be configured to search for videos across different VSPs' platforms (for example, the video services 112a, 112b, 112c, . . . , 112n), notwithstanding whether a user to which the visual interface (such as the first visual interface 116a) is provisioned is a member (or subscriber) to a particular VSP.

At 618, an availability and a lowest price value of the first video from the plurality of subscribed VSPs and the plurality of unsubscribed VSPs, may be determined. The SCR processor 202 may be further configured to determine the availability and the lowest price value of the first video from the plurality of subscribed VSPs (such as the VSP 108a and 108b) and the plurality of unsubscribed VSPs (such as the VSP 108c, . . . , 108n). The video service (such as the video service 112c or 112a) in which the availability and the lowest price value for the first video is determined, may be selected for the recommendation.

At 620, a server load may be determined for each of a set of video servers managed by plurality of subscribed VSPs and the plurality of unsubscribed VSPs. The server load may be determined at a time instant associated with the search of the first video. The set of video servers may correspond to those video servers in which the availability of the first video is determined. The SCR processor 202 may be configured to determine the server load for each of the set of video servers (such as the video servers 110a, 110b, 110c, . . . , 110c). The video server (such as the video server 110c) in which the determined server load may be lowest from the set of video servers may be recommended to view the first video.

At 622, a video service managed by a second VSP from the plurality of subscribed VSPs and the plurality of unsubscribed VSPs, may be recommended to view the first video selected from the first visual interface. The recommendation may be done based on the search across the plurality of video services 112a, 112b, 112c, . . . , 112n. In some embodiments, the first VSP and the second VSP may refer to same VSP. In some embodiments, the first VSP and the second VSP may be different.

At 624, a direct navigation to the first video may be provided for the playback of the first video from the recommended video service managed by the second VSP. The user 118a may not require to search for the first video again from a second visual interface (for example, from a home page) managed by the second VSP that provides the recommended video service. The VID controller 206 may be configured to provide the direct navigation to the first video for the playback of the first video from the recommended video service.

At 626, playback of the first video from the recommended video service managed by the second VSP, may be controlled. The VID controller 206 may be configured to control playback of the first video from the recommended video service (such as the video service 112c) managed by the second VSP (such as the VSP 108c).

At 628, an input for a first scene to be searched within the first video may be received via the first visual interface. The SCR processor 202 may be configured to receive the input, by the network interface 208. At 630, the first scene may be searched within the first video based on at least one of closed captioning information or sub-titles of the first video to start playback of the first video from the first scene. The SCR processor 202 may be configured to search for the first scene within the first video based on closed captioning information or sub-titles of the first video to start the playback of the first video from the first scene. In some embodiments, the SCR processor 202 may be further configured to search the first scene, based on the received input, across a plurality of videos managed by the plurality of subscribed VSPs and the plurality of unsubscribed VSPs. The search for the first scene may be executed based on closed captioning information or sub-titles of the plurality of videos to start playback of a portion of a video that corresponds to the first scene. The control may pass to end 632

In accordance with an embodiment of the disclosure, a video streaming management system for enhanced display control of a visual interface for enhanced user engagement is disclosed. In accordance with an embodiment, the video streaming management system 102 may be associated with a plurality of subscribed VSPs and and a plurality of unsubscribed VSPs. The video streaming management system 102 may comprise one or more processors (such as the SCR processor 202 and the VID controller 206). The VID controller 206 may be configured to control display of the first visual interface. The first visual interface may comprise a set of representations that corresponds to a set of videos. The first visual interface may be managed by a first VSP of the plurality of subscribed VSPs. The SCR processor 202 may be configured to receive an input for a first video via the first visual interface. The SCR processor 202 may be further configured to search for the first video, based on the received input, across the plurality of video services 112a, 112b, 112c, . . . , 112n managed by the plurality of subscribed VSPs and the plurality of unsubscribed VSPs. The SCR processor 202 may be further configured to recommend a video service managed by a second VSP from the plurality of subscribed VSPs and the plurality of unsubscribed VSPs to view the first video selected from the first visual interface. The recommendation may be based on the search. The VID controller 206 may be further configured to control playback of the first video from the recommended video service managed by the second VSP.

Various embodiments of the disclosure may provide a non-transitory computer-readable medium and/or storage medium, wherein there is stored thereon, a machine code and/or a set of instructions executable by a machine and/or a server to control display of the first visual interface. The first visual interface may comprise a set of representations that corresponds to a set of videos. The first visual interface may be managed by a first VSP of the plurality of subscribed VSPs. An input for a first video may be received via the first visual interface. The first video, based on the received input, may be searched across the plurality of video services 112a, 112b, 112c, . . . , 112n managed by the plurality of subscribed VSPs and the plurality of unsubscribed VSPs. A video service managed by a second VSP from the plurality of subscribed VSPs and the plurality of unsubscribed VSPs, may be recommended to view the first video selected from the first visual interface. The recommendation may be based on the search. Playback of the first video from the recommended video service managed by the second VSP, may be controlled.

Based on the controlled display of the first visual interface (such as the first visual interface 116a or the visual interface 402), it may be convenient for a user (such as the user 118a or the user 406a) to search for videos across different VSPs' platforms, via the first visual interface notwithstanding whether a user to which the first visual interface is provisioned is a member (or subscriber) to a particular VSP. Additionally, along with the videos, each of the VSPs that have the first video (e.g. a desired video) available may also be ascertained and then presented to the user, irrespective of the user's subscription or non-subscription to the VSPs. The display of the first visual interface may provide a meliorated user experience and enhance user engagement. The individualization or personalization of the set of representations that correspond to the set of videos for each user of the plurality of users 118 may not only encourage the users to spend more time in the subscribed network 114 but also emotionally tie the consumer(s) closer to the subscribed product or service.

Currently, conventional video distribution and streaming systems usually have a fixed number of videos available for distribution. From a VSP's perspective, it is not only difficult to acquire all the video content desired by various users, but also to consistently engage and retain the consumers. Further from a user's perspective, it may be difficult to choose one video streaming service, such as Netflix, Hulu, and the like, over other, due a variation in features, availability of video content, cost of services, and user interfaces of such streaming services provided by different VSPs. In contrast, the disclosed VID controller 206 of the video streaming management system 102 controls display of the first visual interface that is content driven, where the SCR processor 202 allows a user to search for a video title across the plurality of video services 112a, 112b, 112c, . . . , 112n managed by the plurality of subscribed VSPs and the plurality of unsubscribed VSPs. The SCR processor 202 in association with VID controller 206 provides a particular concrete solution to an internet centric-problem of video searching from a same visual interface across multiple different VSPs, even if a user who performs the search may not be subscribed to all of the different VSPs when the search of the video is executed. The video streaming management system 102 improves the server-related technology by allowing the server to perform the search operation across the plurality of video services 112a, 112b, 112c, . . . , 112n managed by both the plurality of subscribed VSPs and the plurality of unsubscribed VSPs for the recommendation of a suitable video service, which may not be previously performable by the server system.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a server system with a set of instructions, when executed, may control the server system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system, comprising:
at least one processor in a video streaming management system that is associated with a plurality of subscribed video service providers and a plurality of unsubscribed video service providers, said at least one processor is configured to:
control display of a first visual interface comprising a set of representations that corresponds to a set of videos, wherein said first visual interface is managed by a first video service provider of said plurality of subscribed video service providers;
receive an input for a first video via said first visual interface;
search for said first video, based on said received input, across a plurality of video services managed by said plurality of subscribed video service providers and said plurality of unsubscribed video service providers;
recommend a video service managed by a second video service provider from said plurality of subscribed video service providers and said plurality of unsubscribed video service providers to view said first video selected from said first visual interface based on said search; and
control playback of said first video from said recommended said video service managed by said second video service provider.

2. The system according to claim 1, wherein said at least one processor is further configured to segregate said received input for said first video into a significant portion and a non-significant portion for a pattern-based search for said received input via said first visual interface, wherein at least one video is additionally searched and recommended for view along with said first video based on said pattern-based search of said significant portion.

3. The system according to claim 1, wherein said at least one processor is further configured to determine an availability and a lowest price value of said first video from said plurality of subscribed video service providers and said plurality of unsubscribed video service providers.

4. The system according to claim 3, wherein said at least one processor is further configured to select said video service, managed by one of said plurality of subscribed video service providers and said plurality of unsubscribed video service providers for said recommendation, in which said availability and said lowest price value for said first video is determined.

5. The system according to claim 3, wherein said at least one processor is further configured to determine a server load for each of a set of video servers managed by said plurality of subscribed video service providers and said plurality of unsubscribed video service providers, wherein said server load is determined at a time instant associated with said search of said first video for said set of video servers in which said availability of said first video is determined.

6. The system according to claim 5, wherein said at least one processor is further configured to receive a video stream of said first video from a video server in which said determined server load is lowest from said set of video servers, wherein said video server in which said determined server load is lowest from said set of video servers corresponds to said recommended video service managed by said second video service provider to view said first video.

7. The system according to claim 1, wherein said at least one processor is further configured to provide a direct navigation to said first video for said playback of said first video from said recommended said video service managed by said second video service provider, independent of a requirement to re-search said received input from a second visual interface managed by said second video service provider.

8. The system according to claim 1, wherein said at least one processor is further configured to search for a first scene within said first video based on at least one of closed captioning information or sub-titles of said first video to start said playback of said first video from said first scene.

9. The system according to claim 1, wherein said at least one processor is further configured to search a first scene, based on said received input, across a plurality of videos managed by said plurality of subscribed video service providers and said plurality of unsubscribed video service providers, based on at least one of closed captioning information or sub-titles of said plurality of videos to start playback of a portion of a second video that corresponds to said first scene.

10. The system according to claim 1, wherein said at least one processor is further configured to receive user-information for a plurality of users associated with a plurality of display devices communicatively coupled to said video streaming management system.

11. The system according to claim 10, wherein said at least one processor is further configured to classify said plurality of users associated with said plurality of display devices based on a plurality of user segmentation parameters.

12. The system according to claim 1, wherein said at least one processor is further configured to select said set of representations that correspond to said set of videos for placement on said first visual interface rendered on a display device, based on a plurality of defined criterions that includes: a video viewing habit of a user associated with said display device, a plurality of user segmentation parameters, a list of current trending videos in a social network, a plurality of specified parameters in a user profile of said user of said display device, and a local weather condition of a geographical area in which said display device is located.

13. The system according to claim 12, wherein said at least one processor is further configured to determine a placement of different video categories on said first visual interface using a layout that is selected based on said plurality of defined criterions, wherein said set of representations are segregated into said different video categories in said layout.

14. The system according to claim 1, wherein said first video service provider and said second video service provider are same.

15. A video streaming management method, comprising:
in a video streaming management system that is associated with a plurality of subscribed video service providers and a plurality of unsubscribed video service providers:
controlling, by least one processor in said video streaming management system, display of a first visual interface comprising a set of representations that corresponds to a set of videos, wherein said first visual interface is managed by a first video service provider of said plurality of subscribed video service providers;
receiving, by said least one processor, an input for a first video via said first visual interface;
searching, by said least one processor, for said first video, based on said received input, across a plurality of video services managed by said plurality of subscribed video service providers and said plurality of unsubscribed video service providers;
recommending, by said least one processor, a video service managed by a second video service provider from said plurality of subscribed video service providers and said plurality of unsubscribed video service providers to view said first video selected from said first visual interface based on said search; and
controlling, by said least one processor, playback of said first video from said recommended said video service managed by said second video service provider.

16. The method according to claim 15, further comprises segregating, by said at least one processor, said received input for said first video into a significant portion and a non-significant portion for a pattern-based search for said received input via said first visual interface, wherein at least one video is additionally searched and recommended for view along with said first video based on said pattern-based search of said significant portion.

17. The method according to claim 15, further comprising determining, by said at least one processor, an availability and a lowest price value of said first video from said plurality of subscribed video service providers and said plurality of unsubscribed video service providers.

18. The method according to claim 17, further comprising selecting, by said at least one processor, said video service, managed by one of said plurality of subscribed video service providers and said plurality of unsubscribed video service providers for said recommendation, in which said availability and said lowest price value for said first video is determined.

19. The method according to claim 17, further comprising determining, by said at least one processor, a server load for each of a set of video servers managed by said plurality of subscribed video service providers and said plurality of unsubscribed video service providers, wherein said server load is determined at a time instant associated with said search of said first video for said set of video servers in which said availability of said first video is determined.

20. The method according to claim 19, further comprising receiving, by said at least one processor, a video stream of said first video from a video server in which said determined server load is lowest from said set of video servers, wherein said video server in which said determined server load is lowest from said set of video servers corresponds to said recommended video service managed by said second video service provider to view said first video.

21. The method according to claim 15, further comprising providing, by said at least one processor, a direct navigation to said first video for said playback of said first video from said recommended said video service managed by said second video service provider, independent of a requirement to re-search said received input from a second visual interface managed by said second video service provider.

22. The method according to claim 15, further comprising searching, by said at least one processor, for a first scene within said first video based on at least one of closed captioning information or sub-titles of said first video to start said playback of said first video from said first scene.

23. The method according to claim 15, further comprising searching, by said at least one processor, a first scene, based on said received input, across a plurality of videos managed by said plurality of subscribed video service providers and said plurality of unsubscribed video service providers, based on at least one of closed captioning information or sub-titles of said plurality of videos to start playback of a portion of a second video that corresponds to said first scene.

24. The method according to claim 15, further comprising selecting, by said at least one processor, said set of representations that correspond to said set of videos for placement on said first visual interface rendered on a display device, based on a plurality of defined criterions that includes: a video viewing habit of a user associated with said display device, a plurality of user segmentation parameters, a list of current trending videos in a social network, a plurality of specified parameters in a user profile of said user of said display device, and a local weather condition of a geographical area in which said display device is located.

25. The method according to claim 24, further comprising determining, by said at least one processor, a placement of different video categories on said first visual interface using a layout that is selected based on said plurality of defined criterions, wherein said set of representations are segregated into said different video categories in said layout.
